(19) United States
(12) Patent Application Publication
(10) Pub. No.: US 2001/0052900 A1
(43) Pub. Date: Dec. 20, 2001

(54) Apparatus and method for inputting chinese characters

(76) Inventor: Kwan-Dong Lee, Daejeon (KR)

Correspondence Address: TransPotomac Plaza, 1033 N. Fairfax St., Suite 306, Alexandria, VA, 22314, US

(21) Appl. No.: 09/822,221

(22) Filed: Apr. 2, 2001

(30) Foreign Application Priority Data
Apr. 3, 2000 (KR) 2000-17395
Feb. 8, 2001 (KR) 2001-6038
Mar. 20, 2001 (KR) 2001-14238

(51) Int. Cl. G06T 11/00

(52) U.S. Cl. 345/467

(57) ABSTRACT

The present inventions relates to an apparatus and method for inputting Chinese characters, and more specifically to an apparatus and method for inputting a Chinese character by generating the Chinese character designated by the inputted radical key and the combination key from a memory mean.

And the present invention provides an apparatus and method for inputting easily and simply Chinese characters and inputting a lot of Chinese characters for a specified time, and inputting all Chinese character at less than four strokes.

The present invention comprises a Chinese character radical key including a plurality of radical keys for representing radicals constituting a designated Chinese character being inputted and a plurality of combination keys for representing a combination frame of the designated Chinese character being inputted, a signal converter for converting a signal from the radical key and combination key into a signal which can be processed at next stage, a memory mean for storing the designated Chinese character according to the radical and combination frame and a Chinese character generating mean for generating the Chinese character designated by the inputted radical key and combination key from the memory mean.

### BACKGROUND OF THE INVENTION

1. Field of the Invention

The present inventions relates to an apparatus and method for inputting Chinese characters, and more specifically to an apparatus and method for inputting a Chinese character by generating the Chinese character designated by the inputted radical key and the combination key from a memory mean.

2. Background of the Invention

There are a lot of languages in the worldwide. However, It is not simple to input all of them on a computer. Hangul alphabet or the English letter, which is composed of the a consonant and a vowel, can be easily displayed on it. On the other hand, Chinese characters is particularly difficult to display on the keyboard because of their language characteristic. It's the reason that there are a large number of letters corresponding to a consonant and a vowel of the Hangul alphabet and their combination methods as well as a large number of Chinese characters to be made by themselves. In addition, there are letters which become Chinese character by themselves, and although letters do not become Chinese character by themselves, there are many letters formig Chinese character by combining any other radicals or Chinese characters.

Many kinds of methods for inputting Chinese characters, traditionally, have been already introduced. Fist of all, there is one method for converting Hangul alphabet into Chinese character. After inputting a phonetic transcription of Chinese character being inputted in Hangul alphabet, when a user presses a Chinese character conversion key, Chinese character(s) corresponding to the phonetic transcription is(are) displayed on any other screen sequentially according to the frequency of use. The Chinese character which the user wants to input is inputted by selection of the corresponding Chinese character among Chinese character(s) on the screen. However, this is not a method for inputting Chinese characters by direct stroke, but for inputting Chinese characters by converting Hangul alphabets into Chinese character. In addition, the method has included following problems that a user, who was not acquainted with Chinese character, had a lot of difficulty of selection of Chinese character as well as many times of key inputting. There is another method, called as a Chinese character mode method, for converting a convertible Chinese character into the word unit of the Chinese character. Namely, two delimiters for designating the range of Hangul alphbet's word, which user wants to convert into Chinese character, is set in left side and right side respectively of Hangul alphabet's words. When words being converted into Chinese characters is inputted in Hangul alphabet between left side delimiter and right side delimiter, All Chinese characters corresponding to the Hangul alphabet's words are showed on the screen. subsequently, the Hangul alphbet-Chinese character conversion is implemented by a user's choosing one. But, this is a method for inputting Chinese character by indirect strokes too. In addition the above method caused following problems. Because a user has to designate conversible range in front and rear of the words which will be converted into Chinese character by function key or specified mark and has to distinguish Chinese character with Hangul alphabet one by one, such works have been very inconvenient. In addition, a memory effect has been lower according to a great consumption of a memory capacity because all words and compound words are loaded within database in advance. Moreover, Because the above method is no more than usage of dictionary including a lot of words, a word which does not exist in the database can not be inputted.

Currently, a widely known method for inputting Chinese characters from computer keyboard is classified into Five-Stroke Character Form and Haneo-ByungEum. The Five-Stroke Character Form provides a method for inputting Chinese characters indirectly (not by direct stroke). The stroke of Chinese character is converted into a predetermined number within a computer respectively, and a English letter corresponding to the number is then converted into Chinese character respectively. It is not easy for common user to use the method, because a user must bear in mind the number corresponding to the Chinese character stroke as well as English letter corresponding to the number.

Moreover, Haneo-ByungEum provides a method for inputting Chinese characters to be converted from the English pronunciation by typing English pronunciation of Chinese character as it is. However, in order to use Haneo-ByungEum, a user is able to read and write the English pronunciation in English corresponding to Chinese character. Therefore, it has been inconvenient for users who has been not educated to use English keyboard for typing Chinese characters.

And there are typically other known methods, called as Phonetic transcription Alphabet method, Chang-Hil Suip method and so on. In the Phonetic transcription Alphabet method, Phonetic transcription Alphabet corresponding to a phonetic symbol of Chinese character are displayed on the keyboard, and a user inputs the Phonetic transcription Alphabet corresponding to the phonetic symbol of the Chinese character which user desires to input into computer. Then a plurality of Chinese characters, which have been stored in advance in a database, are displayed on the screen. subsequently, a user clicks and choose one. However, the above method provided the same operation as Hangul alphabet inputting method and English letter inputting method does. In addition, it was not to input Chinese character directly (by direct stroke), but to input a kind of mark according to English pronunciation of a Chinese character. And then, a user selects one among the plurality of Chinese characters. In case that users could not read Chinese character they want to input, they were not able to use this method. A different method, Chang-Hil Suip method, for inputting Chinese character into computer, exists also. Chinese characters corresponding to the English letter are displayed on the English letter keyboard, and a plurality of radicals or Chinese characters corresponding to the displayed Chinese character are stored in the database of the computer respectively. When English alphabets corresponding to the radicals or Chinese characters constituting a Chinese character being inputted are inputted into a computer, the computer perceives the plurality of stored radicals or Chinese characters in the database respectively. Wherein, a Chinese character, which can be formed by combining all of radicals or Chinese characters, is already stored in another database. Then if English alphabets are inputted completely, the computer makes a Chinese character to be inputted. In other words, when all alphabets corresponding to each Chinese character are inputted from the left side to the right side completely, a predetermined(stored in the database in advance) Chinese character corresponding to the alphabets is displayed on the screen. However, database's capacity had to be enough to input all Chinese characters in the above method, and all of Chinese characters had to be stored in the database in advance. Moreover, users had to memory the indicated Chinese characters on the keyboard.

Because Phonetic transcription Alphabet method and Chang-Hil Suip method, are not to input Chinese characters by direct stroke, but to input Chinese character by converting English alphabets into Chinese characters, these methods is similar to Haneo-ByungEum and Five-Stroke Character Form in relation to a indirect inputting method of Chinese characters. Therefore, there were typically some problems because we didn't input radicals or compound Chinese characters by direct stroke in the prior art.

### SUMMARY OF THE INVENTION

The present inventions relates to an apparatus and method for inputting Chinese characters, and more specifically to an apparatus method for inputting a Chinese character by generating the Chinese character designated by the inputted radical key and the combination key from a memory mean.

And the present invention provides an apparatus and method for inputting easily and simply Chinese characters and inputting a lot of Chinese characters for a specified time, and inputting all Chinese character at less than four strokes.

The present invention comprises a Chinese character input key mean including a plurality of radical keys for representing radicals constituting a designated Chinese character being inputted and a plurality of combination keys for representing a combination frame of the designated Chinese character being inputted, a signal converter for converting a signal from the radical key and combination key into a signal which can be processed at next stage, a memory mean for storing the designated Chinese character according to the radical and combination frame and a Chinese character generating mean for generating the Chinese character designated by the inputted radical key and combination key from the memory mean.

The present invention provides an apparatus for inputting Chinese characters into a information processing device, the apparatus comprises a Chinese character input key mean having a plurality of radical keys for representing radicals which constitute a Chinese character respectively and a plurality of combination keys for representing a combination frame of radicals which constitute a Chinese character respectively, a memory mean for storing a plurality of Chinese characters according to said radicals and said combination frame and a Chinese character generating mean for generating said Chinese character designated by one more radical key and combination key from said memory mean. The present invention further comprises means for displaying a designated Chinese character. Wherein said plurality of combination keys include a kind of combination keys uniting combination keys having a similar frame among all Chinese character combination frames, the number of said combination keys is 20˜35, and the number of said radical keys is 146˜214.

And the number of said inputting rest radical key(s) is 1˜3, wherein when the number of said rest radicals are 3, a radical inputted at third stroke is a last radical key according to the order of strokes of said designated Chines character.

Then present invention further comprises a plurality of Chinese character radical keys for inputting completed Chinese characters constituting said Chinese character.

In addition, the present invention provides a method for inputting Chinese characters by generating a designated Chinese character from memory mean storing Chinese characters, by inputting a Chinese character input key mean which includes a plurality of radical keys representing radicals constituting Chinese character and a plurality of combination keys representing combination frame of said radicals, the method comprises the steps of (a) inputting a radical key representing a radical selected from a plurality of radicals constituting said designated Chinese character, (b) inputting a combination key corresponding to said designated Chinese character and (c) inputting rest radical key(s) representing one more rest radical selected from said plurality of radicals constituting said designated Chinese character; and (d) generating a Chinese character designated by said inputted radical key, combination key and rest radical key(s) sequentially from memory mean. Wherein the radical key inputted in step (a) is one that represents the first radical or the last radical according to the order of strokes of said designated Chinese character.

The method further comprises a step of discriminating whether said designated Chinese character was designated and a step of displaying a designated Chinese character.

### BRIEF DESCRIPTION OF THE DRAWINGS

FIG. 1 depicts a block diagram representing the construction of Chinese characters input an apparatus of the present invention.

FIG. 2 depicts a table representing designated Chinese characters stored in memory mean as shown in FIG. 1 in accordance with an apparatus for inputting Chinese character of the present invention.

FIG. 3 depicts a typical classification table of radicals in which is applied to the present invention in accordance with a scheme.

FIG. 4 depicts a construction of key means in accordance with a preferred embodiment of the present invention.

FIG. 5 depicts a classification table of Chinese character corresponding to a combination frame in accordance with a preferred embodiment of the present invention.

FIG. 6 depicts an arrangement plan depicted in FIG. 3 in accordance with a preferred embodiment of the present invention.

FIG. 7 depicts a flowchart of a process for illustrating the method for inputting a Chinese character in accordance with the present invention.

### DESCRIPTION OF THE PREFERRED EMBODIMENT

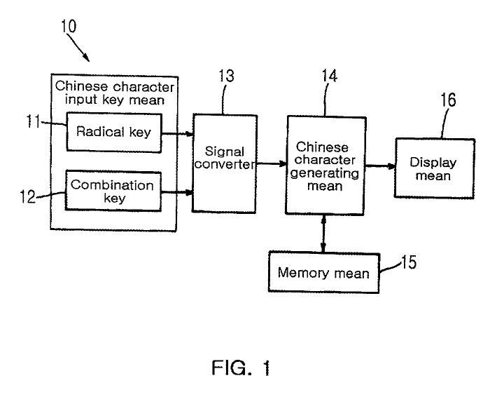

With reference now to the figures, FIG. 1 illustrates a block diagram representing the construction of apparatus for input Chinese characters of the present invention. The apparatus comprises a Chinese character input key mean having a plurality of radical keys 11 and a plurality of combination keys 12, a signal converter 13, a memory mean 15 and a Chinese character generating mean 14. Preferably, the apparatus can further comprise a display mean 16 for outputting a completed Chinese character, as shown in FIG. 1.

The radical key 11 represents radicals constituting a Chinese character respectively. The combination key 12 represents combination frames of radicals to form the Chinese character. The signal converter 13 converts signals from the Chinese character input key mean 10 into a signals which can be processed at next stage. The memory mean 15 stores a plurality of designated Chinese characters according to the radical and/or combination frame. And the Chinese character generating mean 14 generates the Chinese character designated by one more radical key and combination key from the memory mean 15.

Throughout the discussion herein of the present invention, the term “radical” refers to the least unit of a letter constituting a Chinese character.

The Chinese character input key mean 10 is inputted by inputting the radical key and/or combination key, wherein a Chinese character is designated by a signal from the Chinese character input key mean 10, generated from the memory mean 15 and inputted.

Once the radical key 11 is inputted, a radical, which is represented on the radical key 11, is inputted directly. Wherein the inputting of radical constituting a Chinese character is implemented by the inputting of the radical key 11, and the inputting of combination frame is implemented by the inputting of combination key 12.

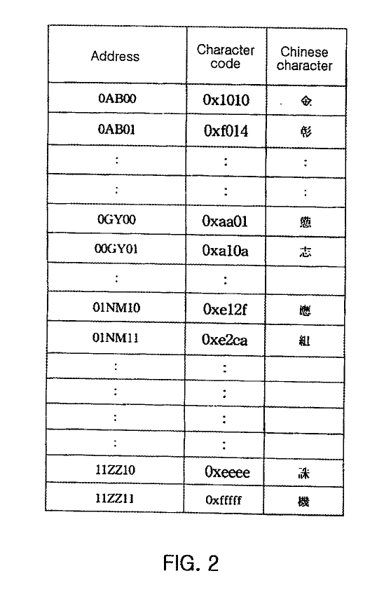

The memory mean 15 stores a plurality of designated Chinese characters according to radicals and combination frame. FIG. 2 depicts a table representing designated Chinese characters stored in memory mean as shown in FIG. 1 in accordance with an apparatus for inputting Chinese character of the present invention. As shown in FIG. 2, the memory mean 15 stores all Chinese character being inputted, the Chinese characters have character codes corresponding to the addresses respectively. For example, if signal from the radical key 11 and combination key 12 is sent to the Chinese character generating mean 14 as character code 0xf014 through the signal converter 13, a Chinese character ‘ [symbol] ’ corresponding to the code 0xf014 is generated from the memory, as shown in FIG. 2.

FIG. 2 illustrates a sample of the designated Chinese characters which are stored in the memory mean 15. Those of ordinary skill in the art will appreciate that the table format, addresses and codes and etc can be modified and replaced. Furthermore, the memory mean 15 can have a wide variety of types.

The signal converter 13 converts signals from the inputted radical key 11 and combination key 12 into other signals which can be processed at the Chinese character generating mean 14 respectively. The converted signals are sent to the Chinese character generating mean 14. The Chinese character generating mean 14 generates a Chinese character designated by the signals of the inputted radical key 11 and combination key 12 from the memory mean 15. The display mean 16 then display the designated Chinese character. The Chinese character generating mean 14 can designate a Chinese character by just only inputting of one radical key 11, wherein the Chinese character is composed of just only one radical.

In case of inputting a Chinese character, user inputs first radical key 11, and then inputs combination key 12 of the Chinese character. The signal from the inputted radical key 11 and the combination key 12 are sent to the Chinese character input key mean 14 through the signal converter 13. The Chinese character generating mean 14 generates a Chinese character designated by the radical key 11 and combination key 12 from the memory mean 15. Wherein inputting radical key 11 may be one which comes first or which comes last according to the order of strokes of the Chinese character.

In addition, according to the present invention, user inputs first radical key 11 corresponding to a Chinese character being inputted, inputs a combination key 12, and then inputs the rest radical key 11 representing the rest radical(s) constituting the Chinese character. Then the Chinese character generating mean 14 generates a Chinese character designated by the inputted one more radical key 11 and combination key 12 sequentially. In other words, when a radical key 11 is inputted first, a combination key 12 is then inputted, and rest radical key 11 is inputted, a Chinese character, which is designated by the inputted radical key 11, the combination key 12 and the rest radical key 11, is generated from the memory mean 15. Wherein the number of the rest radical key 11 is 1˜3. Although a Chinese character is composed of more than five radicals, the number of inputting radical key after the inputting of combination key 12 is 3 at most. Wherein a radical key 11 inputted at third stroke is one which comes last according to the order of strokes of the Chinese character.

The number of radical keys is preferably 146˜214, and that of combination key is preferably 20˜35.

The present invention can further comprise a plurality of Chinese character key mean, wherein input Chinese characters representing a verb, an adjective, a preposition, a postposition and so forth, and Chinese characters corresponding to a instructions and contradictions respectively. In addition to, Chinese characters which are frequently used in sentence or combined very often with any other radical or Chinese character.

The operation of the Chinese character generating mean 14 can be implemented in a computer software or a microcomputer, and preferably can be implemented in a microprocessor.

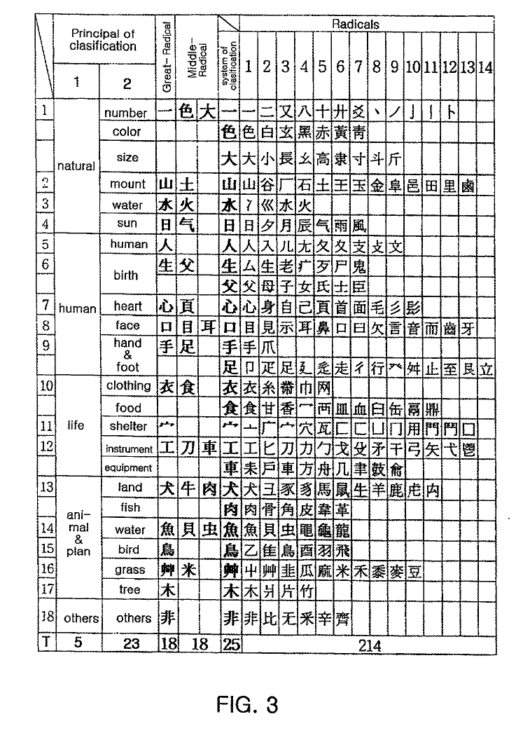

Referring now to FIG. 3, FIG. 3 shows a typical classification table of radicals in which is applied into the present invention in accordance with a scheme. As shown in FIG. 3, radicals of the present invention comes from Kang-Hee Character Dictionary's 214 radicals. The radicals are displayed and classified into a Great-Radical, Middle-Radical, Radical, Partial-Radical and a Belong Character in accordance with ‘A method for classifying and system for arranging according to radical 18 letters (KR 10-1999-037758)’ by applied the present applicant. Among the 214 radicals from the dictionary, the Great-Radical is classified into Nature, Human, Life, Animal/Plant and Others according to their meaning, and more classified into 18 units. The Middle-Radical is classified into a meaning firstly and a position secondly, and then classified into 18 also. Both the Great-Radical and Middle-Radical are then displayed on the radical key 11.

And the Partial-Radical and Belong Character is classified into their meaning and sequence of stroke according to the Great-Radical and Middle-Radical. Therefore, the 214 radicals are classified and displayed as shown in the table in FIG. 3 finally.

The 25 representative radicals are formed by the Great-Radical and Middle-Radical, and then 214 radicals are classified according to the 25 representative radicals. The defined classification of the radicals as shown in FIG. 3 is a help for user to learn and remember the all radicals. The radicals are used in the present invention. Wherein, radicals, which can be combined by any other radicals, were excepted from a display on the radical key 11 because it is possible to input the radicals by using the present invention as described in following. In other words, 68 radicals were excepted from the 214 radicals in the Kang-Hee Character Dictionary, such as ‘ [symbol] ’ which can be formed by combining ‘ [symbol] ’ and ‘ [symbol] ’. And the rest 146 radicals are displayed on the radical key 11.

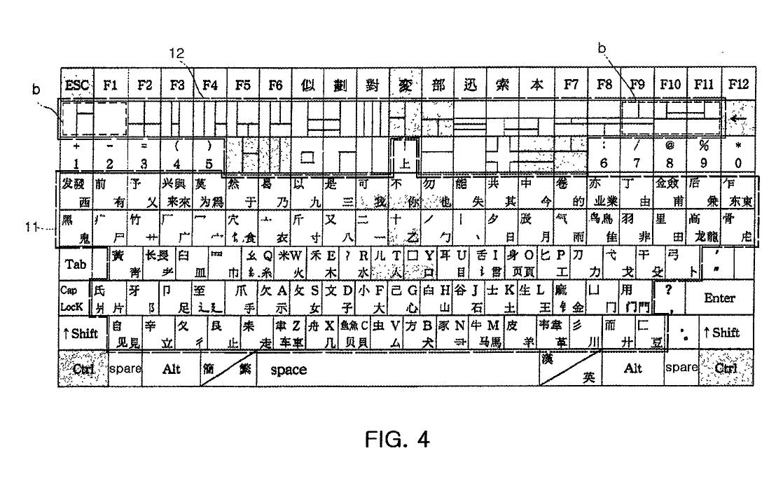

Referring now to FIG. 4, there is generally illustrated radical keys of an apparatus for inputting Chinese characters in accordance with a preferred embodiment of the present invention.

Moreover, FIG. 4 illustrates radicals or Chinese characters which are inputted by the radical key 11 and combination frames which are inputted by the combination key 12, in accordance with a preferred embodiment of the present invention.

As shown in FIG. 4, the Chinese character input key mean 10 of the apparatus comprises a plurality of radical keys 11 for representing radicals constituting a Chinese character, and a plurality of combination keys 12 for representing a combination frame of the radicals to form a Chinese character. The keys 11, 12 may be arranged in any position according to a preferred embodiment as shown in FIG. 4.

Moreover, function keys are not essential component of the present invention, but there are a large number of function keys which perform other functionality for compatible relation with a typical keyboard as shown in FIG. 4.

As shown in the FIG. 4, the number of the combination keys 12 is preferably 20˜35 units, and is limited to 30 in present invention. All Chinese character can be inputted by the combination keys 12 of FIG. 4.

The combination keys 12 are widely classified into two types according to the usage of them. The one type is 5 units, which are the leftmost 2 units and the rightmost 3 units of the combination keys 12 in FIG. 4, are used when the last radical is inputted firstly to input a Chinese character. In other words, the type is used when a user wants to input a Chinese character by inputting a last radical firstly. The other type is 25 units except the above 5 units that are the leftmost 2 units and the rightmost 3 units of the combination keys 12. The 25 units are used when a user wants to input a Chinese character by inputting a first radical firstly. Wherein, the first and last radical is one which comes firstly and lastly respectively according to the order of strokes.

The first type, 5 units are marked with ‘b’, as shown in FIG. 4. The combination keys b represent the leftmost 2 units and the rightmost 3 units as shown in FIG. 4. It is important to note that the combination keys 12 comprises the two types combination keys 12 (‘b’ and the others except ‘b’).

Particularly, the 5 units, the combination keys b are now described in detail.

The combination keys b are used to input a Chinese character which is inputted at more than five strokes by using the combination keys 12 (except the ‘b’) more easily and simply. For example, when a last radical key 11 according to the order of strokes is inputted firstly and a combination key b is then inputted, a Chinese character, which is designated by the inputted radical key 11 and the combination key b, is generated from the memory mean 15. And then the designated Chinese character is inputted. However, if the designated Chinese character are not designated, a first radical is inputted additionally, wherein the first radical is one which comes first according to the order of strokes of the Chinese character. The Chinese character, which is designated by the inputted first, last and the combination frame, is then generated from the memory mean 15.

While the combination key b input a combination frame like the combination keys 12 (except ‘b’), the functions of both processing by the Chinese character generating mean 14 are different. Namely, when the combination key except from ‘b’ is inputted, the last radical key is inputted first, and the Chinese character generating mean 14 generates a Chinese character by one more radical key 11 and combination key except from b.

However, when the last radical according to the order of stroke is inputted and then the combination key b is inputted, the first radical key 11 is inputted first, and the Chinese character generating mean 14 generates a Chinese character by one more radical key 11 and combination key b. Wherein, the a Chinese character has been already stored in the memory mean 15.

The combination key b allows a Chinese character, which can be inputted at much more strokes, to be inputted at less stroke and more easily. Those of ordinary skill in the art will appreciate that the number of the Chinese character input key mean 10, positions and etc can be modified.

For the convenience of description, just radical key 11, the combination key 12 are marked, as shown in FIG. 4.

In order to describe the present invention in detail, there is now concretely described about the operations of the keys 11, 12 and the Chinese character generating mean 14, not depicted, referring to FIG. 4.

The radical key 11 represents radicals constituting a Chinese character, the inputting of the radical key 11 makes result in the inputting radical. Wherein radical is inputted by inputting directly the radical key 11. If the inputting of a Chinese character being inputted can be provided from only radical key 11, the only radical key 11 can input a Chinese character by direct stroke. For example, if a user whose name is ‘ [symbol] ’ desires to input his name into information processing device such as computer, it is possible for him to input ‘ [symbol] ’, ‘ [symbol] ’, ‘ [symbol] ’ one stroke each by direct strokes by using the radical key 11 respectively. Wherein signals corresponding to the inputted ‘ [symbol] ’, ‘ [symbol] ’ and ‘ [symbol] ’ are sent to the Chinese character generating mean 14 through the signal converter 13, and the Chinese character generating mean 14 generates the Chinese character ‘ [symbol] ’, ‘ [symbol] ’ and ‘ [symbol] ’ from the memory mean 15. The ‘ [symbol] ’, ‘ [symbol] ’ and ‘ [symbol] ’ are stored in the memory mean 15 in advance and are designated by the inputted ‘ [symbol] ’, ‘ [symbol] ’ and ‘ [symbol] ’ radical key 11.

The radical, which is inputted by the radical key 11, is classified into two types according to its usage. One is called ‘origin radical’, the other is called ‘Chinese character’. Those of ordinary skill in the art will appreciate that some Chinese characters can be used as radical, and there can be a case on the contrary too.

The Chinese characters (except from the origin radical), which are distinguished from above radicals, are displayed on the radical key 11 (as called Chinese character key mean) according to the following three principals.

The first one is that Chinese characters having Simplified Chinese Character are displayed with regard for its importance in usage and frequency of use. Currently, The Simplified Chinese Character has highly practical use in China because of a policy. The second one is that Chinese characters including a important meaning in sentence, such as a verb, an adjective, a preposition, a postposition and so forth, are displayed, and Chinese characters corresponding to a instructions and contradictions is also displayed respectively. The last one is that a Chinese characters, which are frequently used in sentence or combined very often with any other radical or Chinese character, are selected and displayed on the radical key 11.

Through the depicted principals, it's possible to display Chinese characters on the Chinese character key mean and to input them. However, it is important to note that the radicals or Chinese characters, which are displayed on the key mean as shown in FIG. 4, are presenting a preferred embodiment of radical and Chinese character of the present invention. As shown in above, 214 radical from Kang-Hee Chinese Dictionary are classified according to some principal, and radical keys 11 represents 146 radicals except from 68 radicals which are composed of other radicals among the 214 radicals.

Those of ordinary skill in the art will appreciate that the radical or Chinese character is capable of being modified or replaced.

The combination key 12 will be now described in detail.

Most of Chinese characters are composed of radicals. Wherein, the combination of radicals can be implemented through a combination key 12. For example, if ‘ [symbol] ’ is inputted secondly, after ‘ [symbol] ’ is inputted firstly, ‘ [symbol] ’ is then inputted sequentially. However, ‘ [symbol] ’ or ‘ [symbol] ’ may be inputted according to the inputting combination frame. In other words, if a left-right combination frame is inputted, ‘ [symbol] ’ is inputted. The other hands, if a up-down combination frame is inputted, ‘ [symbol] ’ is inputted. As depicted in above, in order to input a Chinese character, the combination key 12 must be inputted at second stroke. The sequence is shown in following description.

If a Chinese character being inputted is composed of two radicals, the inputting sequence is ‘radical key 11+combination key 12+radical key 11’. And if a Chinese character being inputted is composed of three radical or Chinese characters, the inputting sequence is ‘radical key 11+combination key 12+radical key 11+radical key 11’. Furthermore, if, four, ‘radical key 11+combination key 12+radical key 11+radical key 11+radical key 11’. Therefore the combination key 12 must be inputted at second stroke as shown in above examples.

According to the present invention, although a Chinese character is composed of more than four radicals, the Chinese character can be inputted.

In case of inputting a Chinese character which is composed of more than four radicals or Chinese characters, a user inputs a first radical key 11 according to the order of strokes of the Chinese character, and then inputs a combination key 12 of the Chinese character being inputted. It is discriminated whether a Chinese character was designated. If a Chinese character is not designated by this time, the user further inputs a next radical at second stroke. When it is determined that a Chinese character is designated by the inputted the first, second radical key 11 and the combination key 12, the designated Chinese character is then inputted. However, if not designated, the user further inputs a next radical additionally at third stroke. It is also discriminated whether a Chinese character was designated. If not designated, the last radical or Chinese character is inputted at fourth stroke. Finally, a Chinese character is designated by the inputted one more radical key 11 and combination key 12, and then is generated from the memory mean 15. Wherein, the last radical is one which comes first according to the order of strokes, and the designated Chinese character which was stored in the memory mean 15 in advance. It is important to note that the first radical key is inputted at first stroke, the combination key is then inputted, the second and third radical key are inputted sequentially according to the order of strokes, and the fourth stroke must cause the inputting of the last radical key which comes last according to the order of strokes. Therefore, a complicate Chinese character, which is composed of more than four radical key, is designated by inputting the radical key at less than four stroke.

For example, although ‘ [symbol] ’ is composed of six radicals, the ‘ [symbol] ’ can be inputted at four strokes. When ‘ [symbol] ’, which is the first radical key 11 according to the order of stroke, is inputted, a up-down combination key representing [symbol] is then inputted, and ‘ [symbol] ’, which is the last radical key 11 according to the order of stroke, is then inputted, a completed Chinese character ‘ [symbol] ’ is inputted finally. Wherein, the completed Chinese character must be stored in the memory mean 15 in advance. Namely, when the first radical key, last radical key and the combination key representing [symbol] are inputted, a Chinese character must be designated by these radical keys 11 and the combination key 12. The corresponding stored Chinese character ‘ [symbol] ’ is then inputted. In above example, when radical key 11 representing ‘ [symbol] ’+up-down combination key representing [symbol] +radical key 11 representing ‘ [symbol] ’ are inputted sequentially, ‘ [symbol] ’ is designated and generated from the memory mean 15.

According to the present invention, it is possible to input a Chinese character more easily by the combination keys 12, especially the combination keys b which located on leftmost 2 units and rightmost 3 units, as shown in FIG. 4.

If a Chinese character being inputted is composed of more than five radicals, the inputting of the Chinese character is implemented through the complicate process and many keying. However, the combination key b has a functionality of inputting Chinese characters more easily and simply. First of all, the last radical key 11 according to the order of strokes among a plurality of radicals constituting one Chinese character being inputted. And a combination key b is then inputted. The Chinese character generating mean 14 generates a Chinese character designated by the inputted radical key 11 and combination key b. If a Chinese character is not designated, subsequently user inputs the first radical key 11 according to the order of strokes of the Chinese character additionally. Then a Chinese character is designated by the inputting of the first and last radical keys 11 and the combination key b. Finally the designated Chinese character is generated from the memory mean 15, and inputted. Wherein, the completed Chinese character must be stored in the memory mean 15 in advance.

The combination key b may be for users, who are acquainted with Chinese characters, to input Chinese character more easily at less stroke. Of course, a Chinese character which is inputted by using the combination key b, can be inputted by using the other combination keys 12 (except the combination keys b).

The combination keys 12 include several type, such as two-type, three-type and four-type combination key. In case that a Chinese character is composed of two radicals, a two-type combination keys are used to input the Chinese character. the two-type combination keys comprises generally more than 10 units, but the present invention provides only 6 units. In case of Chinese character comprising radicals such as ‘ [symbol] ’, ‘ [symbol] ’, ‘ [symbol] [symbol] ’, ‘ [symbol] ’, a combination frame [symbol] is used in common. And in case of Chinese character comprising radicals such as ‘ [symbol] ’, ‘ [symbol] ’, ‘ [symbol] ’, ‘ [symbol] ’, ‘ [symbol] ’, a combination frame [symbol] is used in common. In this manner, the two-type combination key is limited to 6 units in the present invention.

The three-type combination keys are also limited to 6 units. Chinese character of inputting by three strokes in respect of the type and the order of strokes, and three strokes in the keying is limited to 6 units according to the characteristic of each Chinese character. And four-type combination keys are limited to 13 units in the same manner as shown in above two-type and three-type combination keys. A Chinese character comprising more than five strokes is programed to be inputted at less than four strokes. As shown in above, a Chinese character, which is composed of more than five radicals, is designated by inputting the plurality of radical or Chinese characters at less than four strokes, and can be inputted.

As shown in above description, the present invention provides the representative combination keys 30 which can be used in common among a lot of combination keys representing the all Chinese character. For example, the origin combination key corresponding to ‘ [symbol] ’ is ‘ [symbol] ’. However ‘ [symbol] ’ is used instead of that. And the origin combination key corresponding to ‘ [symbol] ’ is used [symbol] instead of [symbol] . In addition [symbol] is used instead of [symbol] , and [symbol] is used instead of [symbol] .

Therefore, the common and changeable parts of combination frame of all Chinese characters are united into some combination frame, and the combination keys 12 are limited 30 units by uniting into similar frames.

The combination frame, which is represented on the combination key 12, is formed into 30 units as shown if FIG. 4 by being abstracted a plurality of some combination frame from all of Chinese characters in respect of combination frame of Chinese characters. And the combination key 12 can cover all Chinese character. In a preferred embodiment, the combination key 12 of the present invention includes all of combination frame.

The present invention provides a preferred embodiment of the combination frame. Those of ordinary skill in the art will appreciate that the combination frame, which is inputted by the combination key 12, may be modified or replaced. Moreover, a increment of the number of combination key 12 is accompanied by a space of keyboard, and a decrease of that is accompanied by the increment of keying. Therefore, the number of the combination keys 12 is preferably 20˜35.

Because a Chinese character is not written from left side to right side like English letters, the Chinese character is inputted by using the combination key 12 into device, such as a computer.

Referring now to ‘ [symbol] ’, for example, if user inputs the just radical key 11 representing ‘ [symbol] ’ and ‘ [symbol] ’ respectively, ‘ [symbol] ’, which is two Chinese characters, is inputted and displayed sequentially on a display such as a computer monitor. The result represents ‘WOMAN’. However, the ‘ [symbol] ’ is not ‘ [symbol] ’. The ‘ [symbol] ’ does not represent ‘WOMAN’, but ‘LIKE’ or ‘WANT’. the ‘ [symbol] ’, which is one Chinese character by itself, is composed of ‘ [symbol] ’ and ‘ [symbol] ’. Furthermore, ‘ [symbol] ’ is combined by two character ‘ [symbol] ’ and ‘ [symbol] ’ in accordance with left-right configuration. In order to input the combined Chinese character ‘ [symbol] ’ into a display by inputting the radical keys 11 representing ‘ [symbol] ’ and ‘ [symbol] ’ respectively, the combination key 12 is used surely as shown in above description.

The radical key 11 of ‘ [symbol] ’ is inputted first, the combination key 12 of [symbol] which is displayed on the combination key 12 is then inputted, and then the radical key 11 of the rest character ‘ [symbol] ’ is inputted. The result is that the ‘ [symbol] ’ is designated by inputted radical key 11 of ‘ [symbol] ’, the combination key 12 of [symbol] , and radical key 11 of ‘ [symbol] ’. And the designated ‘ [symbol] ’, which represents ‘LIKE’ or ‘WANT’ as depicted in above description, is generated from the memory mean 15 finally. The designated Chinese character was stored in the memory mean 15.

In this manner, it is also possible to input the Chinese character combined into up-down configuration. For example, in case of inputting ‘ [symbol] ’, the radical key 11 of ‘ [symbol] ’ is inputted first, and the combination key 12 of [symbol] corresponding to the combination frame of ‘ [symbol] ’ is then inputted. The radical key 11 of the rest radical ‘ [symbol] ’ additionally is inputted by direct stroke. The result is that a completed Chinese character ‘ [symbol] ’, which is designated by the inputted radicals keys 11 representing ‘ [symbol] ’ and ‘ [symbol] ’, and combination key 12 representing the combination frame [symbol] , is generated from the memory mean 15. Finally the Chinese character ‘ [symbol] ’ is inputted. Wherein, the Chinese character generating mean 14 generates a stored Chinese character ‘ [symbol] ’ by the inputting the radical keys 11 of ‘ [symbol] ’ and ‘ [symbol] ’ and the combination key 12 of [symbol] from the memory mean 15.

It is possible to input a Chinese character more easily by using the combination keys 12, especially the combination keys b. For example, in case of inputting ‘ [symbol] ’ by using the combination keys b, the last radical key 11 of the last radical ‘ [symbol] ’ according to the order of strokes is inputted first of all. And a combination key b of [symbol] shown in FIG. 2 is inputted. Then a Chinese character, with the inputted combination frame [symbol] , which is formed by combining the last radical into the last combinative position (white part, not black part), is then designated and generated from the memory mean 15. Wherein, the ‘ [symbol] ’ is stored in the memory mean 15 in advance. In this example, when both the radical key 11 of ‘ [symbol] ’ and the combination key b of [symbol] are inputted sequentially, the Chinese character generating mean 14 generates a completed Chinese character ‘ [symbol] ’ which comprises the ‘ [symbol] ’ and the combination frame [symbol] .

However, if a Chinese character is not designated, the first radical key 11 according to the order of strokes is inputted additionally. Then, a completed Chinese character, with the combination frame, comprising the inputted first and last radical key 11, is inputted.

However, if a Chinese character is not designated, the first radical key 11 is then inputted. Then a Chinese character, with the inputted combination frame, is designated by the inputted radical key 11 and combination key 12. For example, in case of inputting ‘ [symbol] ’, a user inputs the last radical key 11 of ‘ [symbol] ’, and a combination key 12 of [symbol] in FIG. 4. Wherein, a Chinese character is not designated and not generated. When the first radical key 11 of ‘ [symbol] ’, according to the order of strokes is inputted additionally, finally a completed Chinese character ‘ [symbol] ’, which is stored in the memory mean 15 in advance, is designated and generated from the memory mean 15.

Therefore, when the radical key 11 of ‘ [symbol] ’, the combination key 12 of [symbol] and rest radical key 11 of ‘ [symbol] ’ are inputted sequentially, designated ‘ [symbol] ’ is generated by the inputted radicals (‘ [symbol] ’ and ‘ [symbol] ’) and the combination frame [symbol] from the memory mean 15 in the present invention.

The depicted samples is just some samples of the present invention. In this manner, the Chinese character which is more complicatedly combined as well as left-right or up-down combinative construction can be also inputted by inputting the combination key 12 corresponding to Chinese character each other. Of course, the combination frame is possible to be modified and replaced according to a Chinese character being inputted.

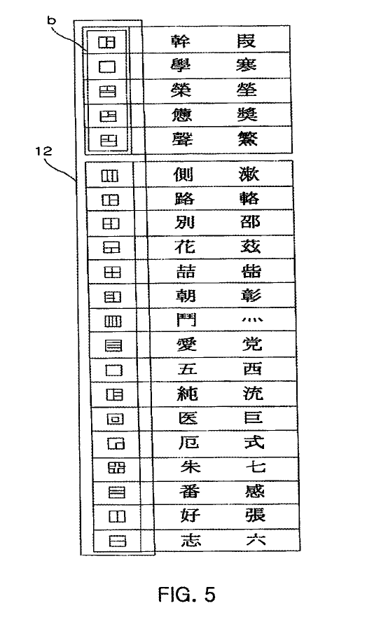

Referring now to FIG. 5, FIG. 5 illustrates a classification table of Chinese character corresponding to a combination frame in accordance with a preferred embodiment of the present invention. FIG. 5 shows a example of the classification table applied to the present invention. As shown in FIG. 5, the combination frames applied to the present invention are shown vertically on the left side, and Chinese characters corresponding to the each combination frame are shown on the right side. Moreover, the combination frames corresponding to the combination keys b are set on the top place, and the combination frames to the combination keys 12 (except the ‘b’) are set the bottom place. For example, Chinese characters combined in a left-right combination frame [symbol] are ‘ [symbol] ’ and ‘ [symbol] ’, further ‘ [symbol] ’, ‘ [symbol] ’ and so on. Chinese characters combined in a up-down combination frame [symbol] are ‘ [symbol] ’ and ‘ [symbol] ’, further ‘ [symbol] ’, ‘ [symbol] ’ and so on. It is important to note that those skilled in the art will appreciate that FIG. 5 shows a example of combination frame in accordance with a preferred embodiment of the present invention and just two Chinese characters corresponding to the combination frames are shown in FIG. 5 respectively.

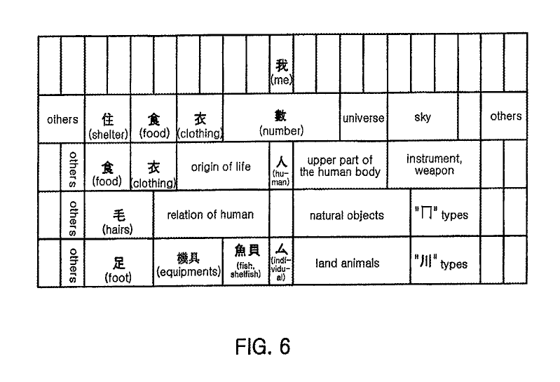

Referring now to FIG. 6, FIG. 6 illustrates an arrangement plan of the radicals (including completed Chinese characters) which are represented on the radical key 11, as depicted in FIG. 4 in accordance with a preferred embodiment of the present invention.

A method for inputting Chinese characters is different from that of Hangul alphabets with right and left hands by turns when user uses the keyboard which is disposed of consonants on the left side and vowels on the right side. Therefore, radicals are disposed according to the following principal so that user uses the apparatus and method of the present invention more easily and learns in mind the classified radicals and Chinese characters.

First of all, ‘ [symbol] ’ is disposed in the center based on the human central idea. ‘ [symbol] ’ representing ‘ME’ is disposed on the top of the ‘ [symbol] ’, and ‘ [symbol] ’ representing ‘an INDIVIDUAL’ is disposed on the bottom of the ‘ [symbol] ’. Then ‘ [symbol] ’, ‘ [symbol] ’ and ‘ [symbol] ’ form a vertical axis.

Moreover, ‘ [symbol] ’ is disposed between the ‘ [symbol] ’ and ‘ [symbol] ’. On the left side and right side of the ‘ [symbol] ’, Chinese characters representing ‘Origin of Life’ and ‘the Upper part of Human body’ are disposed respectively. Chinese characters representing ‘Human’ are disposed on the left side of the vertical axis and Chinese characters representing ‘Nature’ are disposed on the right side of that. This disposition is shown in FIG. 6. Referring to FIG. 6, the ‘Human’ and the ‘Nature’ Chinese characters are more subdivided according to the meaning group and classified according a scheme.

FIG. 6 illustrates a preferred embodiment of the present invention so that a user uses and learns more easily radicals applied to the present invention. The radicals of the classification table can, of course, be modified and replaced by those of skilled in the art.

Furthermore, the present invention provides a method for inputting Chinese characters. and provides a method for inputting radical at less stroke by using the radical key 11 and the combination key 12 corresponding to Chinese character being inputted.

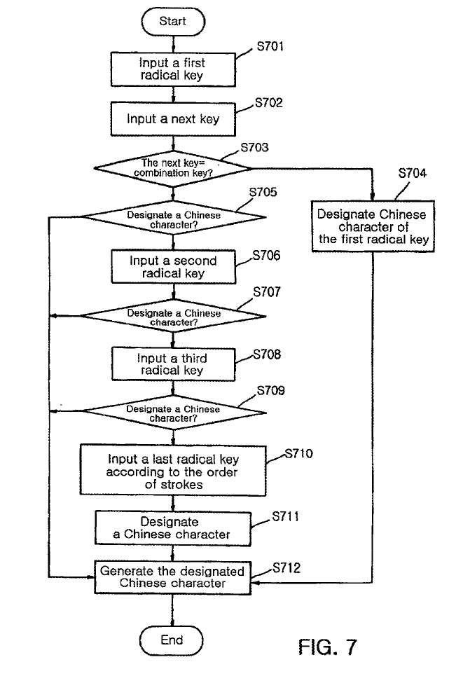

Referring now to FIG. 7, FIG. 7 illustrates a flowchart representing a method for inputting Chinese characters in accordance with the present invention.

A first radical key 11 is inputted selected from one more radical key 11 representing the radicals constituting a Chinese character being inputted (S701). The inputting radical key 11 in step S701 can be the one which comes first or last radical key 11 according to the order of strokes, according to a kind of the combination keys 12 which a user wants to use. This was explained in above examples.

Then the next key is inputted (S702). It is discriminated whether the next key is a combination key 12 which represents combination frame of the radicals constituting the Chinese character being inputted or not (S703). The combination frame is a predetermined structure to form a Chinese character, and the combination keys 12 include a kind of combination keys uniting combination keys having a similar frame among all Chinese character combination frames.

When it is determined in step S703 that the combination key has not been inputted, the process is advanced forward a next step (S704). The radical of the radical key 11 which is inputted in the step S701 is displayed finally (S704). This processes apply to a Chinese character that is composed of just only one radical, without having combination frame.

For example, in case of inputting a Chinese character ‘ [symbol] ’, the one radical key 11 corresponding to ‘ [symbol] ’ is inputted by direct stroke (S701). The next key is inputted (S702). In this example, because inputting of a Chinese character ‘ [symbol] ’ is finished perfectly, the next key being inputted is not combination key 12. Therefore any other radical key is inputted. Because the next key is not combination key, “NO” is determined as shown in FIG. 7. The process is advanced forward a step (S704) and the inputted radical ‘ [symbol] ’ is designated (S705) and generated from the memory mean 15 (S712).

On the other hand, when it is determined in the step S703 that a combination key 12 is inputted, the process is advanced forward a next step S705. In step S705, it is discriminated whether a Chinese character was designated. When it is determined in the step S705 that a Chinese character was designated by the inputted radical key 11 and the combination key 12, then the designated Chinese character is generated by the Chinese character generating mean 14 from the memory mean 15 (S712). When it is determined in the step S705 that a Chinese character was not designated, a second radical key 11 is inputted additionally (S706). The second radical key 11 can be the one which comes first or second radical key 11 according to the order of strokes, according to a kind of the combination keys 12 which a user wants to use.

Then, it is determined in step S707 that a Chinese character was designated by the inputted radical key 11 and the combination key 12. When it is determined that a Chinese character was designated, the designated Chinese character is then generated from the memory mean 15 (S712). However, when it is determined that a Chinese character was not designated, a third radical key 11 is inputted additionally (S708). It is discriminated in step S709 that whether a Chinese character was designated (S709). If designated, the Chinese character generating mean 14 generates the designated Chinese character from the memory mean 15, and if not designated, the last radical key 11 according to the order of strokes is then inputted additionally (S710). The Chinese character is designated by the inputted one more radical key 11 and combination key 12 (S711). Wherein the Chinese character generating mean 14 generates the designated Chinese character from the memory mean 15 (S712). The each designated Chinese character in the above steps are stored in the memory mean 15 in advance. Wherein, it is important that the inputting of the last radical key 11 must occur at fourth stroke. Therefore, the present invention provides a method for inputting Chinese character at less than four strokes.

Referring now to the embodiments, the method for inputting Chinese characters of the present invention is described.

For example, in case of inputting one Chinese character ‘ [symbol] ’, the first radical key 11 representing ‘ [symbol] ’ is inputted (S701). Because inputting of the Chinese character ‘ [symbol] ’ being inputted is completed and does not include any other radical with itself, the next input key is not the combination key 12 (S703). Therefore, it is determined that the next key is not the combination key 12 (S703), and the first radical ‘ [symbol] ’ is then designated (S704) and generated by the inputted radical key 11 (S712).

However, in case of inputting a Chinese character ‘ [symbol] ’, the first radical key 11 representing ‘ [symbol] ’ which constitutes the one Chinese character is inputted (S701). Because the Chinese character ‘ [symbol] ’ has a left-right type of combination frame, the inputting of next key is combination key 12 corresponding to the combination frame of the Chinese character (S702). Therefore, the combination key 12 representing the left-right type of combination frame [symbol] is then inputted. As depicted in above, when it is determined in the step S703 that the next key is the combination key 12, it is discriminated whether a Chinese character was designated (S705). Because ‘ [symbol] ’ is combined with ‘ [symbol] ’ to form a Chinese character ‘ [symbol] ’, a Chinese character would not be designated. Therefore, a second radical key 11 of ‘ [symbol] ’ is inputted additionally (S706). Then a Chinese character ‘ [symbol] ’ is designated by the radical keys 11 and combination key 12 representing ‘ [symbol] ’, combination frame [symbol] and ‘ [symbol] ’, inputted sequentially (S707). The designated Chinese character ‘ [symbol] ’ is generated by the inputted radical key 11 and combination key 12 from the memory mean 15 (S712).

If it is, however, determined in the step S703 that the next key is not the combination key 12, the first radical ‘ [symbol] ’ is only designated (S704) and generated from the memory mean 15 (S712), as illustrated in above example.

In other words, when radical keys 11 and combination key 12 representing the ‘ [symbol] ’, the combination frame [symbol] and the ‘ [symbol] ’ respectively are inputted sequentially, a Chinese character ‘ [symbol] ’ is designated (S707) and generated by the inputted radical key of the ‘ [symbol] ’, combination key of the combination frame [symbol] and the rest radical key 11 of ‘ [symbol] ’ (S712).

Referring to additional example, in case of inputting a Chinese character including a plurality of radicals, such as ‘ [symbol] ’, the first radical key 11 of ‘ [symbol] ’ is inputted (S701). In order to input ‘ [symbol] ’, a next key must be combination key 12 representing a combination frame [symbol] corresponding to the Chinese character ‘ [symbol] ’ (S702). It is discriminated that the next key is combination key 12 (S703). When it is determined in step S703 that the inputted next key was the combination key 12, the process is advanced to a next step (S705) and discriminates whether a Chinese character is designated (S705). However, a Chinese character ‘ [symbol] ’ is not designated by this time (S707), and is not designated after a second radical key 11 representing ‘ [symbol] ’ and a third radical key 11 representing ‘ [symbol] ’ are inputted sequentially (S706, S707, S708, S709). In other words, though the rest radicals, ‘ [symbol] ’ and ‘ [symbol] ’ are inputted sequentially, a Chinese character is not designated as the result of in each step (S708, S710). Therefore, a last radical key 11 representing the last radical ‘ [symbol] ’ according to the order of strokes of the ‘ [symbol] ’ is then inputted (S710). Then the ‘ [symbol] ’ is finally designated (S711). And the Chinese character generating mean 14 generates the designated Chinese character ‘ [symbol] ’ from the memory mean 15 (S712).

The inputting of four radical key 11 of [symbol] , [symbol] , [symbol] and [symbol] and a combination key 12 of [symbol] results in the designating and generating of a Chinese character ‘ [symbol] ’ (S711, S712).

In this process, the radical key 11 of ‘ [symbol] ’ is inputted first, and then the combination key 12 of [symbol] is inputted. And sequentially ‘ [symbol] ’, ‘ [symbol] ’ and finally ‘ [symbol] ’ is generated respectively. Therefore, a completed Chinese character, ‘ [symbol] ’ is generated through a this mechanism of the present invention.

As shown in above description, the present invention provides a method for input Chinese character more easily and simply by combination keys b among the combination keys 12. In other words, when a last radical key 11 constituting a Chinese character being inputted is inputted firstly (S701) and then a combination key 12 is inputted (S702), a Chinese character is then designated by the inputted last radical key 11 and the combination key b (S705). And then the designated Chinese character is generated (S712). However, if a Chinese character is not designated by the inputted the last radical key 11 and combination key b (S705), user inputs a first radical according to the order of strokes additionally (S706). A Chinese character is designated (S711), and generated by the inputted the first and last radical keys 11 and the inputted combination key b from the memory mean 15 (S712).

For example, in case of inputting one Chinese character, ‘ [symbol] ’ by using the combination key b. First of all, the last radical key 11 of ‘ [symbol] ’ according to the order of strokes is inputted (S701). A next key is then inputted (S702). Wherein, the next is a combination key b in this example. Therefore a combination key b of ‘ [symbol] ’ is inputted (S703). It is determined in the step S703 that the next key was the combination key b (S703). A Chinese character ‘ [symbol] ’ is designated by the inputted radical key 11 of ‘ [symbol] ’ and the combination key b of ‘ [symbol] ’, as the result of step S705. and is then generated from the memory mean 15 (S715) in the present invention. Wherein the Chinese character ‘ [symbol] ’ is stored in the memory mean 15 in advance and is programmed to be designated when the radical key 11 of ‘ [symbol] ’ and a combination key b of [symbol] are inputted sequentially.

However, in case of inputting ‘ [symbol] ’ by using the combination key b, the last radical key 11 of ‘ [symbol] ’ is inputted (S701). And then a user inputs the next key of the combination key b of [symbol] to input ‘ [symbol] ’ (S702). It is discriminated that the next key was a combination key b which indicates the combination frame [symbol] of the Chinese character ‘ [symbol] ’ (S703). Wherein, a Chinese character is not designated by the inputted radical key 11 and combination key b representing the ‘ [symbol] ’ and [symbol] respectively (S705). Therefore, additional inputting of a second radical key 11 representing ‘ [symbol] ’ is completed (S706). Finally a Chinese character ‘ [symbol] ’ is designated by the inputted first and second radical keys 11 and the inputted combination key b, as the result of step S707. Wherein the inputting second radical key 11 is one which comes first according to the order of strokes of ‘ [symbol] ’. Namely, the radical key 11 of ‘ [symbol] ’ is a second radical key 11 in this example.

Then the Chinese character ‘ [symbol] ’ is then designated (S711) and generated by the inputted radical keys 11 and combination key b representing ‘ [symbol] ’, [symbol] and ‘ [symbol] ’ respectively (S712). The ‘ [symbol] ’ has been stored in the memory mean 15 in advance.

According to the present invention, there are cases in which a Chinese character is designated when a radical key 11 is inputted firstly and then a combination key 12 is inputted.

As shown in above description, according to the combination key 12 which a user wants use, a first radical key 11 or a last radical key 11 according to the order of strokes can be inputted firstly.

The present invention provides other advantages that it is possible to input a Chinese character, which is composed of more five radicals, at less than four stroke.

Although the preferred embodiments of the present invention has been disclosed for illustrative purpose, the present invention is not limited to them. Those skilled in the art will appreciate that various modifications, additions and substitutions are possible, without departing from the scope and spirit of the present invention

What is claimed:

1. An apparatus for inputting Chinese characters into a information processing device, said apparatus comprising:
a Chinese character radical key having a plurality of radical keys for representing radicals which constitute a Chinese character respectively and a plurality of combination keys for representing a combination frame of radicals which constitute a Chinese character respectively;
a memory mean for storing a plurality of Chinese characters according to said radicals and said combination frame; and
a Chinese character generating mean for generating said Chinese character designated by a first radical key, combination key and a rest radical key which constitute(s) said Chinese character from said memory mean, inputted sequentially according to the order of strokes of said Chines character,
Whereby a Chinese character which is composed of one more radical key and a combination key is generated.

2. The apparatus of claim 1, which further comprises means for displaying a designated Chinese character.

3. The apparatus of claim 1, wherein said plurality of combination keys include a kind of combination keys uniting combination keys having a similar frame among all Chinese character combination frames.

4. The apparatus of claim 1, wherein the number of said combination keys is 20˜35.

5. The apparatus of claim 1, wherein the number of said inputting rest radical key(s) is 1˜3.

6. The apparatus of claim 5, wherein when the number of said rest radicals are 3, a radical inputted at third stroke is a last radical key according to the order of strokes of said designated Chines character.

7. The apparatus of claim 1, which further comprises a plurality of Chinese character radical keys for inputting completed Chinese characters constituting said Chinese character.

8. An apparatus for inputting Chinese characters into a information processing device, said apparatus comprising:
a Chinese character radical key having a plurality of radical keys for representing radicals which constitute a Chinese character respectively and a plurality of combination keys for representing a combination frame of radicals which constitute a Chinese character respectively;
a memory mean for storing a plurality of Chinese characters according to said radicals and said combination frame; and
a Chinese character generating mean for generating said Chinese character designated by a radical key inputted firstly and a combination key from said memory mean,
Whereby a Chinese character which is composed of one more radical key and a combination key is generated.

9. The apparatus of claim 7, wherein said radical key inputted firstly is one that is a last radical key according to the order of strokes of said designated Chinese character.

10. A method for inputting Chinese characters by generating a designated Chinese character from memory mean storing Chinese characters, by inputting a Chinese character radical key which includes a plurality of radical keys representing radicals constituting Chinese character and a plurality of combination keys representing combination frame of said radicals, said method comprising the steps of:
(a) inputting a radical key representing a radical selected from a plurality of radicals constituting said designated Chinese character;
(b) inputting a combination key corresponding to said designated Chinese character; and
(c) generating a Chinese character designated by said inputted radical key and combination key sequentially from memory mean,
Whereby a Chinese character which is composed of one more radical key and a combination key is generated.

11. A method for inputting Chinese characters by generating a designated Chinese character from memory mean storing Chinese characters, by inputting a Chinese character radical key which includes a plurality of radical keys representing radicals constituting Chinese character and a plurality of combination keys representing combination frame of said radicals, said method comprising the steps of:
(a) inputting a radical key representing a radical selected from a plurality of radicals constituting said designated Chinese character;
(b) inputting a combination key corresponding to said designated Chinese character;
(c) inputting rest radical key(s) representing one more rest radical selected from said plurality of radicals constituting said designated Chinese character; and
(d) generating a Chinese character designated by said inputted radical key, combination key and rest radical key(s) sequentially from memory mean,
Whereby a Chinese character which is composed of one more radical key and a combination key is generated.

12. A method of claim 10 or 11, wherein said radical key inputted in step (a) is one that represents the first radical according to the order of strokes of said designated Chinese character.

13. A method of claim 10 or 11, wherein said radical key inputted in step (a) is one that represents the last radical according to the order of strokes of said designated Chinese character.

14. A method of claim 11, which further comprises a step of discriminating whether said designated Chinese character was designated.

15. A method of claim 11, wherein the number of said rest radical key(s) is 1˜3.

16. A method of claim 15, wherein when the number of said rest radicals are 3, a radical inputted at third stroke is a last radical key according to the order of strokes of said designated Chines character.

17. A method of claim 10 or 11, wherein said plurality of combination keys include a kind of combination keys uniting combination keys having a similar frame among all Chinese character combination frames.

18. The method of claim 17, wherein the number of said combination keys is 20˜35.

19. The method of claim 10 or 11, which further comprises a step of displaying a designated Chinese character.

20. The method of claim 10 or 11, wherein the number of said radical keys is 146˜214.
